(19) United States
(12) Patent Application Publication
(10) Pub. No.: US 2025/0200758 A1
(43) Pub. Date: Jun. 19, 2025

(54) POSITION DETERMINING METHOD, APPARATUS FOR , ELECTRONIC DEVICE, AND STORAGE MEDIUM

(71) Applicant: Beijing Zitiao Network Technology Co., Ltd., Beijing (CN)

(72) Inventors: Panwang PAN, Beijing (CN); Jiao CHEN, Beijing (CN); Cheng CHEN, Beijing (CN); Yunlong LI, Beijing (CN); Meifeng XIAO, Beijing (CN)

(21) Appl. No.: 18/980,758

(22) Filed: Dec. 13, 2024

(30) Foreign Application Priority Data
Dec. 14, 2023 (CN) 202311723077.7

(51) Int. Cl. G06T 7/20

(52) U.S. Cl. CPC G06T 7/20; G06T 2207/20084

(57) ABSTRACT

The present disclosure provides a position determining method, apparatus, electronic device and storage medium. The method includes: inputting a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and performing at least two iterative stages on the initial predicted position to obtain position information of the target object at the target point of time, wherein a positioning accuracy of any iterative stage is higher than a positioning accuracy of a previous iterative stage.

### CROSS-REFERENCE TO RELATED APPLICATION

The present application claims priority of the Chinese Patent Application No. 202311723077.7 filed on Dec. 14, 2023. All the aforementioned patent application is hereby incorporated by reference in its entireties.

### TECHNICAL FIELD

The present disclosure relates to the technical field of computers, and in particular, to a position determining method, apparatus, electronic device, and storage medium.

### BACKGROUND

When an extended reality (such as virtual reality, mixed reality, and augmented reality) device is used, a control component such as a gamepad is typically used to control the extended reality device. A position of the control component is an important basis for controlling a content displayed by the extended reality device.

### SUMMARY

A position determining method, apparatus, electronic device, and storage are provided in the present disclosure.

The following technical solutions are applied in the present disclosure.

In some embodiments, a method for determining a position is provided, comprising: inputting a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and performing at least two iterative stages on the initial predicted position to obtain position information of the target object at the target point of time, wherein a positioning accuracy of any iterative stage is higher than a positioning accuracy of a previous iterative stage.

In some embodiments, an apparatus for determining a position is provided, comprising: a control unit configured to input a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; wherein the control unit is further configured to perform at least two iterative stages according to the initial predicted position to obtain position information of the target object at the target point of time; and wherein a positioning accuracy of any iterative stage is higher than a positioning accuracy of a previous iterative stage.

In some embodiments, an electronic device is provided, comprising: at least one memory and at least one processor, wherein the at least one memory is configured to store a program code, and the at least one processor is configured to execute the program code stored on the at least one memory to implement the aforesaid method.

In some embodiments, a computer-readable storage medium is provided, which stores a program code which, when executed by a processor, causes the processor to perform the aforesaid method.

### BRIEF DESCRIPTION OF DRAWINGS

In conjunction with the accompanying drawings and the following specific embodiments, the above and other features, advantages, and aspects of the various embodiments of the present disclosure will become more apparent. Throughout the drawings, the same or similar reference numerals indicate the same or similar elements. It should be understood that the drawings are schematic, and the components and elements are not necessarily drawn to scale.

FIG. 1 is a schematic diagram of using an extended reality device according to an embodiment of the present disclosure;

FIG. 2 is a flowchart of a method for determining a position according to an embodiment of the present disclosure;

FIG. 3 is a flowchart of a method for determining a position according to an embodiment of the present disclosure;

FIG. 4 is a schematic diagram of a dilated convolution neural network model according to an embodiment of the present disclosure;

FIG. 5 is a schematic diagram of processing of convolutional layers of a dilated convolution neural network model according to an embodiment of the present disclosure; and

FIG. 6 is a structural schematic diagram of an electronic device according to an embodiment of the present disclosure.

### DETAILED DESCRIPTION

It will be understood that before using the technical solutions disclosed in various embodiments of the present disclosure, it is necessary to inform a user of a type of personal information involved in the present disclosure, a scope of use, a usage scenario, etc., and should obtain user authorization in accordance with relevant laws and regulations through appropriate means.

For example, in response to receiving an active request from a user, a prompt message is sent to the user to explicitly prompt the user that the operation the user requests to perform will require to acquire and use the personal information of the user. Thus, the use can independently select, according to the prompt message, whether or not to provide the personal information to software or hardware such as an electronic device, an application, a server or a memory medium that performs the operations of the technical solutions of the present disclosure.

As an alternative but non-limiting implementation, in response to receiving an active request from a user, a manner of sending a prompt message to the user may be, for example, using a pop-up window in which the prompt message may be presented in the form of text. Furthermore, the pop-up window may also carry option controls for a user to select to “agree” or “disagree” to provide personal information to an electronic device.

It will be understood that the processes of notifying of and authorizing by a user described above are merely exemplary and do not constitute a limitation on the implementations of the present disclosure, and other manners meeting relevant laws and regulations may also be applied to the implementations of the present disclosure.

It will be understood that data (including but not limited to data itself, and the acquisition and use of data) involved in the present technical solutions should follow corresponding laws and regulations and requirements of relevant stipulations.

The embodiments of the present disclosure will be described in more detail below with reference to the accompanying drawings. Although certain embodiments of the present disclosure are shown in the drawings, it should be understood that the present disclosure may be implemented in various forms and should not be interpreted as being limited to the embodiments described herein. Instead, these embodiments are provided to achieve a more thorough and complete understanding of the present disclosure. It should be understood that the drawings and embodiments of the present disclosure are for illustrative purposes only and are not intended to limit the scope of protection of the present disclosure.

It should be understood that the steps recorded in the method embodiments of the present disclosure can be executed sequentially and/or in parallel. Moreover, the method embodiments may include additional steps and/or may omit the execution of the steps shown. The scope of the present disclosure is not limited in this regard.

The term “including” and its variations used in this document are open-ended inclusion, meaning “including but not limited to.” The term “based on” means “at least partially based on.” The phrase “one embodiment” indicates “at least one embodiment”; the phrase “another embodiment” indicates “at least one additional embodiment”; and the phrase “some embodiments” indicates “at least some embodiments.” Definitions of other terms will be provided in the following descriptions.

It should be noted that the terms “first,” “second,” etc., mentioned in this disclosure are used solely to distinguish between different devices, modules, or units and do not imply any order or dependency of the functions performed by these devices, modules, or units.

It should also be noted that the modifier “one” mentioned in this disclosure is illustrative rather than restrictive. Those skilled in the art should understand that unless explicitly stated otherwise in the context, it should be interpreted as “one or more.”

Names of messages or information exchanged between a plurality of apparatuses in embodiments of the present disclosure are only used for the purpose of description and not meant to limit the scope of these messages or information.

The solutions provided in the embodiments of the present disclosure will be described in detail below with reference to the drawings.

The extended reality (called XR for short) technology in one or more embodiments of the present disclosure may be the mixed reality technology, the augmented reality technology, or the virtual reality technology. The extended reality technology may combine reality and virtuality by a computer to provide a user with a man-machine interactive extended reality space. In the extended reality space, the user can conduct social interaction, entertainment, learning, work, telecommuting, create user generated content, etc. by means of, e.g., an extended reality device such as a head mount display (HMD).

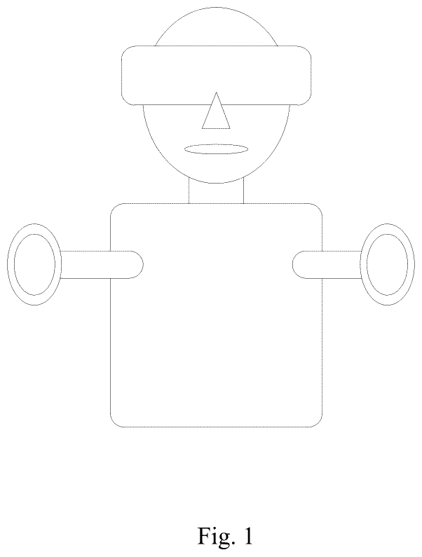

With reference to FIG. 1, the user can enter the extended reality space through the extended reality device such as glasses, and controls his/her own virtual avatar in the extended reality space to conduct social interaction, entertainment, learning, telecommuting, and the like with virtual avatars controlled by other users.

In one embodiment, in the extended reality space, the user can achieve related interactive operations by means of a controller which may be a gamepad. For example, the user perform related operation control by operating keys of the gamepad.

The extended reality device described in the embodiments of the present disclosure may include, but be not limited to, the following several types: computer extended reality device, mobile extended reality device and all-in-one machine extended reality device.

Computer extended reality device utilizes a computer to perform related computation and data output of the extended reality function. An external computer extended reality device achieves the effect of extended reality with data output by the computer.

Mobile extended reality device supports disposing a mobile terminal (e.g., a smart phone) in various ways (e.g., a head mount display with a special clamping groove), and through wired or wireless connection with the mobile terminal, the related computation of the extended reality function is performed by the mobile terminal and data is output to the mobile extended reality device. For example, an extended reality video is watched via an APP of the mobile terminal.

All-in-one machine extended reality device has a processor configured to perform the related computation of the extended reality function and thus has independent extended reality input and output functions, and does not need to be connected with a computer or a mobile terminal with high flexibility of use.

As a matter of course, the implementation forms of the extended reality device are not limited to the above, and the extended reality device may be further miniaturized or enlarged as required.

A posture detection sensor (e.g., a nine-axis sensor) is disposed in the extended reality device, and is configured to detect a posture change of the extended reality device in real time. If the user wears the extended reality device, when the user's head posture changes, a real-time posture of the head is transmitted to a processor for computing the user's point of focus in the extended reality space environment. Images in the user's field of view (i.e., a virtual field of view) in a three-dimensional model of the extended reality space environment are computed according to the point of focus and displayed on a display screen, providing immersive experience like a person viewing in a real environment.

Gamepad tracking solutions may be typically divided into optical tracking (e.g., using a camera for shooting) and integration based on an inertial measurement unit. Optical tracking can provide a high-accuracy position result. However, when the gamepad moves to a shooting blind spot of the camera, accurate position prediction cannot be achieved by optical tracking based on vision. Moreover, the extended reality device typically runs on an embedded terminal and is resource-constrained.

In the related art, integration is performed using sensors. Integration is achieved with information such as a speed and an acceleration over time to obtain a motion trajectory of the gamepad in the shooting blind spot. In such a way, as time goes on, the IMU may have constantly accumulated error due to reasons such as a temperature and noise such that a finally predicted position continuously deviates in a certain direction. The prediction result may be completely not available.

A time sequence is modeled based on a timing network (such as a recurrent neural network (RNN), a long short-term memory (LSTM), a gate recurrent unit (GRU)) to transform position prediction of the gamepad in the shooting blind spot to a timing sequence prediction problem. However, this way must maintain hidden layer information of a neural network model. To maintain the hidden layer information of the neural network model, position prediction needs to be performed when the gamepad is located outside the shooting blind spot. The neural network model must keep running when the gamepad is located in the shooting blind spot and beyond the shooting blind spot.

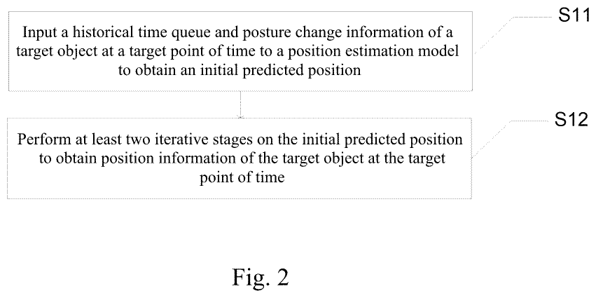

As shown in FIG. 2, which illustrates a flowchart of a method for determining a position according to an embodiment of the present disclosure. The method includes the following steps.

At S11, a historical time queue and posture change information of a target object at a target point of time are input to a position estimation model to obtain an initial predicted position.

In some embodiments, a performing terminal for the method provided in the present disclosure may be any extended reality device in the present disclosure. The extended reality device may include a head mount display device and a matched control device (e.g., other accessories needing to be positioned such as a gamepad, a wristband, and a leg band). Taking the control device being the gamepad as an example, the gamepad may be distinguished between a left-hand gamepad and a right-hand gamepad. The target object may be the left-hand gamepad or the right-hand gamepad of the extended reality device. The method may be used for determining a position of the left-hand gamepad or the right-hand gamepad. The positions of the left and right gamepads generally have no relatively strong correlation, and therefore, the positions of the left-hand gamepad and the right-hand gamepad are separately determined. In some embodiments, the historical time queue is used for storing historical position information of the target object at latest n historical points of time prior to the target point of time, and n is a preset positive integer not less than 2. For example, n may be a positive integer not less than 10, 20, 30, 40, or 50, which may be 60 for example. The historical position information is the position information of the target object at the historical points of time. In some embodiments, the position information may be acquired periodically. The latest n historical points of time may be n historical points of time of n periods prior to the target point of time. For example, 30 periods may be set within 1 second and n may be 60, and the historical time queue may be historical points of time within 2 seconds prior to the target point of time. In some embodiments, the historical point of time and the target point of time may be frame acquisition points of time for a camera to shoot images. The camera may be located on the head mount display device of the extended reality device. There is a light spot for positioning on the target object (e.g., the gamepad), and the camera shoots the light spot on the gamepad so as to acquire information (a position and an angle, etc.) of 6 degrees of freedom of the target object. The camera may periodically shoot images, for example, shoot 30 images per 1 second. When the camera shoots images, the posture change information of the target object may be acquired for determining the corresponding position information when shooting. Therefore, the historical points of time and the target point of time are also frame acquisition points of time for shooting images. Each image shot by the camera corresponds to the posture change information of one target object and the position information determined based on the posture change information. The target point of time may be the last point of time of the camera shooting an image. In some embodiments, when the position information of the gamepad relies on the position information of the head mount display device, the historical time queue also contains the position information such as position, speed, angle, acceleration and/or angular velocity information of the heat mount display device at the historical points of time. In some embodiments, the historical time queue and the posture change information are input to the position estimation model. The position estimation model may be a neural network model. The position estimation model may predict the initial predicted position at one target point of time through computation. The initial predicted position may be expressed with space coordinates.

At S12, at least two iterative stages are performed on the initial predicted position to obtain position information of the target object at the target point of time.

In some embodiments, the number of iterative stages may be 2, 3, or more than 3, which will not be defined. The initial predicted position is low in accuracy and thus cannot be directly used as a position information output at the target point of time, and its accuracy needs to be improved by iterations. The initial prediction position is used as an input to one iterative stage. One predicted stage position of the target object at the target point of time will be output at each iterative stage, and an error corresponding to the stage position may be output together. The stage position is output at the last iterative stage. In this embodiment, a positioning accuracy of any iterative stage is higher than a positioning accuracy of a previous iterative stage. Therefore, positioning from coarse to fine is achieved, gradually approaching the real position of the target object at the target point of time. Specifically, the positioning accuracy may refer to the accuracy of a stage position output from an iterative stage. For example, a deviation of the stage position computed at a first iterative stage from the real position is not greater than 1 cm. At a second iterative stage, it can be guaranteed that a deviation of a stage position from the real position is not greater than 0.2 cm on the basis of the first iteration. In some embodiments, the position information (i.e., the stage position) of the target object at the target point of time determined at a previous iterative stage is corrected with a correction value at each iterative stage, and the accuracy of the correction value of each iterative stage increases gradually. For example, if the accuracy of the correction value determined at one iterative stage is 1 cm, the accuracy of the correction value determined at the next iterative stage is less than 1 cm, e.g., 0.2 cm. In this way, with each iteration, the accuracy of the determined position information of the target object at the target point of time is improved.

In some embodiments of the present disclosure, by using the historical time queue, the previous historical position information of the target object is taken into overall consideration, and determining the position information of the target object at the target point of time in a way from coarse to fine, with each iteration, the method can get closer to the real position of the target object at the target point of time. By combining the two approaches, it is possible to prevent a data offset from increasing continuously. The accuracy and the reliability of the computed position information of the target object at the target point of time are guaranteed.

In some embodiments, after the position information of the target object is determined, the historical time sequence may be updated. According to the first-in first-out principle, the position information of the target object at the target point of time is put into the historical time sequence, and the position information of the target object at the earliest historical point of time is removed from the historical time queue.

In some embodiments of the present disclosure, the following operations are performed at each iterative stage: determining error planes corresponding to a current iterative stage, wherein the error planes have respective error expectations; and a higher positioning accuracy of the current iterative stage indicates a smaller interval between the error expectations of the error planes corresponding to the current iterative stage; determining a probability that an input position falls within each of the error planes corresponding to the current iterative stage, wherein an input position of a first iteration is the initial predicted position, and input positions of other iterative stages are stage positions output from previous iterative stages; correcting the input position according to the probability that the input position falls within each of the error planes and the error expectation corresponding to the error plane to obtain a corrected position; and inputting the corrected position to the position estimation model to obtain a stage position of the current iterative stage.

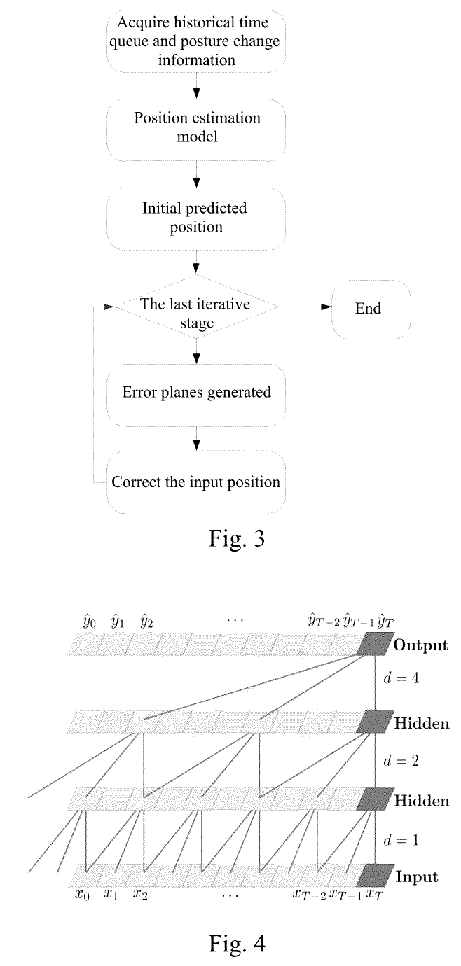

FIG. 3 illustrates a flowchart of a method provided in some embodiments of the present disclosure, including: firstly, acquiring historical time queue and posture change information of a target object at a target point of time and then inputting them to the position estimation model to obtain the initial predicted position. Iterative stages are then performed. In some embodiments, a preset number of error levels are preset. The error planes are divided into different error levels; the error expectations of the error planes of one error level are arranged at an equal interval to form an arithmetic progression; intervals (i.e., equal difference values) of the error expectations of the error planes of different error levels are different; and one iterative stage corresponds to the error planes of one error level. An error plane (also referred to as a loss plane) may be a plane or curved surface of a prediction error. An error plane corresponds to an error expectation, i.e., the error plane is a plane for representing the error expectation, and the computation of the error expectation is converted to the computation of a position by the error plane. If one position falls within only one error plane, an error expectation at this position is the error expectation corresponding to the error plane. However, one position in space may have a plurality of error expectations, which is in essence a probability distribution problem. That is, one position in space may fall within a plurality of error planes, and the possibility of falling within each error plane is described by a probability. In other words, an error expectation corresponding to one position is described by a probability distribution. The corresponding error expectation at one position may be value 1, value 2, or the like. The probability that the error expectation is the value 1, the value 2, or the like may be a probability of falling within an error plane corresponding to the value 1, the value 2, or the like. The error planes are preset and may be pre-trained using known data. Thus, distribution probabilities of the error expectations at different positions are estimated, and the probabilities that the positions fall within the error planes can be known. For example, the error levels may include 10 cm, 1 cm, and 0.2 cm, representing that the error expectations of the error planes of the error levels are arranged at intervals of 10 cm, 1 cm, and 0.2 cm to form arithmetic progressions. One iterative stage corresponds to error planes of one error level. The error expectations of the error planes of one error level are arranged at an equal interval to form an arithmetic progression. For example, the error expectations corresponding to the error planes of the error level of 1 cm may be −4, −3, −2, −1, 0, 1, 2, etc. Firstly, the error level corresponding to the current iterative stage is determined such that the error planes corresponding to the error level are determined. The error planes are planes for evaluating errors. For example, if position information falls within a certain error plane, an error of the position information is the error expectation corresponding to the error plane. Thus, the process of determining an error is converted to a process of determining an error plane. When determining error planes corresponding to the current iterative stage, error planes for which an absolute value of an error expectation is less than an interval of error planes by a preset multiple may be selected. For example, when the interval is 1 cm and the multiple is 4, error planes for which the absolute value of the error expectation is less than 1×4 are determined. A posture optimizer may be used for computation during iteration. At the first iterative stage, the initial predicted position is input to the posture optimizer, the probabilities of falling within the error planes of the current error level can be obtained. The error expectations corresponding to the error planes are then multiplied by the corresponding probabilities and the products are accumulated to obtain a correction value. The correction value is added to an input position to obtain a corrected position, and the corrected position is then input to the position estimation model for computation to obtain a stage position. The stage position output at the last iterative stage is used as the position information of the target object at the target point of time.

For example, suppose that the initial predicted position input at the first iterative stage is 40 cm, the real position is 42.45 cm, and the error level corresponding to the first iterative stage is 1 cm, then the posture optimizer determines that the probabilities of falling within the error planes having the error expectations of −4 cm, −3 cm, −2 cm, −1 cm, 0 cm, 1 cm, 2 cm, 3 cm, and 4 cm are 0.1, 0, 0, 0, 0, 0, 0, 0.9, and 0, respectively. The correction value is −4×0.1+3×0.9=2.3 cm, and the corrected position is 40+2.3=42.3 cm. Since the error level is 1 cm, the 0.3 after the decimal point is uncertain. After 42.3 cm is input to the position estimation model, assuming that the result output by the position estimation model is still 42.3 cm, then this value is the stage position of the first iterative stage. Assuming that there are two error levels, then 42.3 cm is used as the input position to the second iterative stage. Taking that the error level of the second iterative stage is 0.2 cm as an example, as computed by the posture optimizer, the probabilities that the stage position falls within the error planes having the error expectations of −0.2 cm, 0 cm, and 0.2 cm are 0, 0.5, and 0.5. The correction value of the second iterative stage is 0×0.5+0.2×0.5=0.1 cm, and the corrected position of the second iterative stage is 42.4+0.1=42.4 cm. It can be seen that the corrected position is very close to the real position 42.45 cm. After 42.4 cm is input to the position estimation model, the stage position of the second iterative stage will be obtained. If there are only two error levels, the stage position obtained at the second iterative stage is used as the finally output position information of the target object at the target point of time.

In some embodiments of the present disclosure, a cascading and step-by-step boosting approach is used to predict the residual of the previous prediction. During the iterative stage of the residual, simple regression is not used; instead, multiple error planes are generated based on the predicted input position, and the corresponding probability distributions are predicted. By using iteration and error planes, the accuracy of position localization can be gradually improved. This method makes full use of the predictive capabilities of the model and the patterns of error distribution, leading to more accurate position estimation results. The process of continuously refining the error planes allows for a gradual convergence towards the real position of the target, thus improving the precision of position localization.

In some embodiments of the present disclosure, the position estimation model needs to be trained before use, and the training method may be the existing training method for a neural network. During training, by using the data of known real position information and inputting the historical position information and the posture change information for training, the position estimation model outputs the initial predicted position. An iteration is then performed, and an error plane is generated according to an error of an input position and the real position information. The error plane represents an error distribution law of predicted positions. With the error plane, the input position is corrected by regression or optimization such that the corrected input position approaches the real position. In the training process, parameters of the position estimation model and the posture optimizer may be adjusted continuously such that a loss function is reduced. Training ends when the number of iterations reaches a certain number or when the loss function falls below a predefined threshold.

In some embodiments of the present disclosure, different iterative stages are used to determine different bits in a value of the position information of the target object at the target point of time. In some embodiments, the value of the position information may include, for example, tens place, ones place, tenths place, and hundredths place after the decimal point. Different bits in the value of the position information are determined by different iterative stages. In this way, a bit in the value of the position information determined by a preceding iterative stage is higher than a bit determined by a later iterative stage. For example, the tens place is first determined by the first iterative stage; the ones place is determined by the second iterative stage; the tenths place is determined by a third first iterative stage; and the hundredths place is determined by a fourth first iterative stage. In this way, the determined position information is caused to gradually approach the real position information through the process of continuous iterations. In some embodiments, the accuracy of the determined places may be gradually improved by controlling the interval of the error expectations of the error planes corresponding to each iterative stage.

In some embodiments, an absolute value of the error expectations of the error planes determined at the current iterative stage (the current iterative stage may be any iterative stage) is less than the interval of the error planes of the previous iterative stage. For example, the interval of the first iterative stage is 1 cm, and the error expectations of the error planes of the second iterative stage range from −1 cm to 1 cm. In this way, the positioning accuracy can be improved by each iteration.

In some embodiments of the present disclosure, before inputting the historical time queue and the posture change information of the target object at the target point of time to the position estimation model to obtain the initial predicted position, the method further includes: determining whether the target object is located in a shooting blind spot of a camera at n historical points of time in the historical time queue and the target point of time; in response to the target object being located beyond the shooting blind spot at the n historical points of time and the target point of time, using position information of the target object at the target point of time acquired by the camera as the position information of the target object at the target point of time; and in response to the target object being located in the shooting blind spot at at least one selected from the group of the n historical points of time and the target point of time, inputting the historical time queue and the posture change information to the position estimation model to obtain the initial predicted position.

In some embodiments, the historical time queue and the posture change information may be acquired first. It is then determined whether the target object is located in a shooting blind spot of a camera at the historical points of time and the target point of time. Taking that the method is applied to the extended reality device as an example, posture sensors may be disposed in the control device and the head mount display device, e.g., one or more of an acceleration sensor and an angular velocity sensor. Sensor information (e.g., one or more of acceleration information and angular velocity information) of the posture sensor may be acquired as the posture change information, or feature extraction (e.g., integration, with an integration duration from the target point of time to a previous historical point of time) is performed on the sensor information to obtain the posture change information. Specifically, the posture change information may include a speed, an angle, an acceleration and/or an angular velocity of the target object. In some embodiments, in the extended reality device, the head mount display device may be taken as an origin of space, and the position of the control device may be a position relying on the head mount display device. At this point, since the posture change information of the target object relies on the head mount display device, the posture change information of the target object needs to contain posture data such as a position, a speed, an angle, an acceleration and/or an angular velocity of the head mount display device. In some embodiments, the camera periodically shoots images; the points of time for shooting images are frame acquisition points of time; and the target point of time may be a frame acquisition point of time for shooting a previous image, i.e., from the current point of time (inclusive) to the last point of time of the camera shooting an image. Therefore, the posture change information is the posture change information of the target object within the period of time from shooting the last image to shooting an image previous to the last image. The camera may be a camera on the head mount display device, and the target object may be the control device. The target object being located in the shooting blind spot of the camera includes that the camera being unable to capture the target object, and may further include that, although the camera can capture the target object, the shot image cannot be used for determining the position information of the target object (e.g., due to insufficient definition or insufficient number of light spots). At this point, it is also regarded that the target object is located in the shooting blind spot. When the target object is located beyond the shooting blind spot at n historical points of time and the target point of time, it indicates that at this point, the target object has been located at a position that the camera can capture it and there have been a certain duration that the target object is located at the position the camera can capture it. At this point, the position information of the target object can be determined with an image captured by the camera at the target point of time. At this point, the position information of the target object at the target point of time does not need to be determined according to the historical time queue and the posture change information. For example, the position estimation model is a neural network model, and when the target object is located beyond the shooting blind spot at n historical points of time and the target point of time, the position estimation model does not work. Thus, the problem of displacement deviation caused by integration with sensor information for a long time can be avoided. When the target object is located in the shooting blind spot at n historical points of time and the target point of time, the position information of the target object at the target point of time is determined by the position estimation model. The position information may be subjected to Kalman filtering so as to improve the accuracy.

In some embodiments of the present disclosure, the historical time sequence is set so as to save the position information of the target object at n historical points of time. When the target object is located beyond the shooting blind spot at the target point of time and the points of time, the position information of the target object is determined by optical tracking of the camera without using the neural network model to continuously compute the position information of the target object. When the target object is located in the shooting blind spot at the target point of time or the n historical points of time, the position information at the target point of time is predicted using the historical time queue and the posture change information.

In some embodiments of the present disclosure, after determining that the target object is located in the shooting blind spot at at least one selected from the group of the n historical points of time and the target point of time, the initial predicted position is obtained by using the position estimation model; and after determining that the target object is located beyond the shooting blind spot at the n historical points of time and the target point of time, the position estimation model is maintained at or set to a non-operating state.

In some embodiments, since a traditional timing network such as LSTM and GRU needs to use hidden layer data to compute the position information in the shooting blind spot, regardless of where the target object is located, the sequential network needs to continuously compute the position information of the target object. However, in the present disclosure, there is no need to continuously use the position estimation model to predict the position information of the target object. When the target object is not located in the shooting blind spot at the target point of time and the historical points of time, there is no need to use a position prediction model, and the position prediction model remains inactive. There is no need to input the historical time queue and the posture change information to the position prediction model, and the position prediction model is allowed to work only when the target object is located in the shooting blind spot. Thus, the consumption of resources can be reduced. Moreover, in the present disclosure, when the target object is located in the shooting blind spot, the predicted position information refers to the historical position information at n historical points of time, rather than only relies on the posture change information. Thus, a position information offset can be prevented.

In some embodiments of the present disclosure, performing at least two iterative stages according to the initial predicted position to obtain the position information of the target object at the target point of time includes: determining a relative position of the target object at the target point of time to a previous historical point of time, and using the relative position as the position information of the target object at the target point of time; or determining a relative position of the target object at the target point of time to a previous historical point of time, and determining the position information of the target object at the target point of time according to the relative position and historical position information of the target object at the previous historical point of time.

In some embodiments, the determined position information of the target object at the target point of time may be a relative position, i.e., a relative position to the historical position information of a previous historical point of time to the target point of time, or may be an absolute position, e.g., a position expressed with space coordinates.

In some embodiments of the present disclosure, the position estimation model is a dilated convolution neural network model, and a dilatation coefficient of the dilated convolution neural network model is not less than 2.

In some embodiments, a time convolution network processed time sequence is expressed as: for historical sequence x₁ to xₜ, y₁ to yₜ are output; and an output value of the model at point of time t depends on values at the point of time t and historical points of time. The time convolution network differs from the convolutional neural network in that the time convolution network cannot use subsequent data and represents a historical time-constrained model. In order to take full advantage of information for a very long time, the number of convolutional layers and the number of hidden layers must be increased accordingly. The number of convolutional layers and a format of a hidden layer unit will lead to problems of complicated model training, diffusion of gradients of model transfer, and model overfitting. Therefore, in some embodiments of the present disclosure, the dilated convolution neural network model is used, and the inherent problem thereof is that a deep neutral network needs to use an extremely large filter size or filter layer to increase a receptive field of the model. Dilated convolution can process model inputs at equal intervals such that the filter can obtain a larger receptive field. The dilatation coefficient is generally set to an exponential multiple of 2, and the filter is expressed as sequence F=(f₁,f₂ . . . f_{K}), wherein fᵢ is the filter of an i-th layer; K is a total number of layers; and the atrous convolution at input X=(x₁,x₂, . . . x_{T}) with a dilatation rate being equal to d is (F*_{d}X)₍ₓ_{ₜ₎}=Σₖ₌₁^{K} fₖ^{x}_{t-(K-k)d}. A visual representation of dilated convolution is as shown in FIG. 4. As can be seen, for input X, when the dilatation coefficient is 2, the data volume needing to be processed is halved layer by layer. With the dilated convolution neural network model, the receptive field can be widened and the computation complexity can be reduced.

In some embodiments of the present disclosure, the following operations are performed at convolutional layers of the position estimation model: performing preset processing on layer input data of a current convolutional layer twice to obtain layer output data, or performing preset processing on layer input data at least once and then combining the processed data with data from 1×1 convolution on the layer input data to obtain layer output data; wherein layer input data of a first layer of the position estimation model is the historical time queue and the posture change information, and the layer output data of the current convolutional layer is layer input data of next convolutional layer; and the preset processing includes: performing weight parameter normalized dilated convolution processing on the layer input data and then performing non-linear processing using an activation function, and performing processing by a discarding unit.

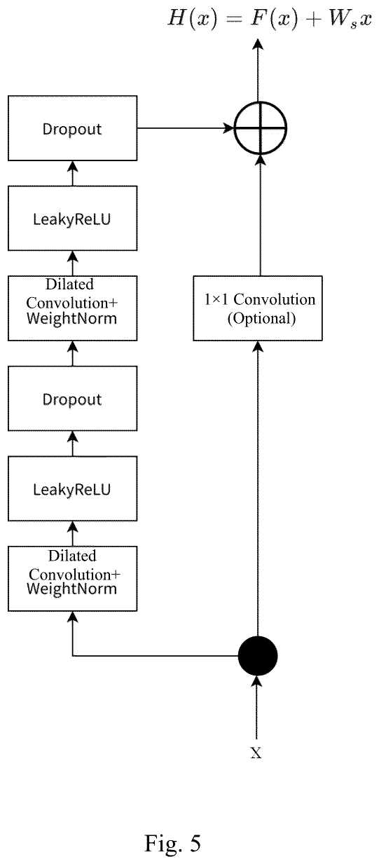

In some embodiments, compared with directly outputting absolute coordinate trajectory of a trajectory, a relative coordinate value is predicted with sensor information so that a network learning mode can be simpler. Therefore, a residual block structure H(x)=F(x)+Wₛx is also established in the present disclosure. As shown in FIG. 5, there is shown an operation performed at each layer of the dilated convolution neural network model. Taking that the layer input data of the current convolutional layer is x as an example, if the convolutional layer is a first layer, x is the historical time sequence and the posture change information; and if the current convolutional layer is other layer, x is layer output data of a previous layer. In order to avoid overfitting, weight parameter normalized dilated convolution processing is performed on x. For the processed data, non-linear processing is performed using LeakyReLU activation function, and an output of a negative semi-axis can be considered. After the above process is successful, Dropout is used for processing to increase robustness. These steps are performed once or multiple times, e.g., twice in FIG. 5, and a final output is expressed by F(x). Meanwhile, optionally, in short-circuited connection, when a feature dimension does not match an output dimension, a 1×1 convolution may be added to perform dimension transformation, and 1×1 convolution operation is performed on the layer input data X, expressed as WₛX. Finally, the layer output data of the current convolutional layer is obtained as: H(x)=F(x)+WₛX.

In some embodiments, taking that the target object is a gamepad as an example, a time convolution network with dilated convolution and residual structures is utilized to predict the position information of the target object in the shooting blind spot. By introducing the dilated convolution and residual structures, the method can be used to predict the position information of the target object in a blind spot more accurately. Secondly, left-hand and right-hand gamepads are decoupled in the present disclosure so that the user can independently control the action of each hand. By decoupling, the user can operate the gamepad more freely, thereby improving the flexibility and diversity of interaction. Moreover, the present disclosure further designs a method for determining position from coarse to fine with good value stability. This method adopts a progressive refinement strategy in the prediction process, including firstly performing coarse prediction and then progressively refining a prediction result. This method can not only improve the accuracy of prediction, but also maintain the stability of values, avoiding an abrupt change and jittering of the prediction result.

In some embodiments of the present disclosure, there is further provided an apparatus for determining a position, including: a control unit configured to input a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; wherein the control unit is further configured to perform at least two iterative stages according to the initial predicted position to obtain position information of the target object at the target point of time; and wherein a positioning accuracy of any iterative stage is higher than a positioning accuracy of a previous iterative stage.

In some embodiments, the following operations are performed at each iterative stage: determining error planes corresponding to a current iterative stage, wherein the error planes have respective error expectations; and a higher positioning accuracy of the current iterative stage indicates a smaller interval between the error expectations of the error planes corresponding to the current iterative stage; determining a probability that an input position falls within each of the error planes corresponding to the current iterative stage, wherein an input position of a first iteration is the initial predicted position, and input positions of other iterative stages are stage positions output from previous iterative stages; correcting the input position according to the probability that the input position falls within each of the error planes and the error expectation corresponding to the error plane to obtain a corrected position; and inputting the corrected position to the position estimation model to obtain a stage position of the current iterative stage.

In some embodiments, the error planes are divided into different error levels; the error expectations of the error planes of one error level are arranged at an equal interval; intervals of the error expectations of the error planes of different error levels are different; and one iterative stage corresponds to the error planes of one error level.

In some embodiments, different iterative stages are used to determine different bits in a value of the position information of the target object at the target point of time.

In some embodiments, the apparatus further includes a determine unit, configured to, before inputting the historical time queue and the posture change information of the target object at the target point of time to the position estimation model to obtain the initial predicted position, determine whether the target object is located in a shooting blind spot of a camera at n historical points of time in the historical time queue and the target point of time.

The control unit is configured to, in response to the target object being located beyond the shooting blind spot at the n historical points of time and the target point of time, use position information of the target object at the target point of time acquired by the camera as the position information of the target object at the target point of time.

The control unit is configured to, in response to the target object being located in the shooting blind spot at at least one selected from the group of the n historical points of time and the target point of time, input the historical time queue and the posture change information to the position estimation model to obtain the initial predicted position.

In some embodiments, the control unit is configured to, after determining that the target object is located in the shooting blind spot at at least one selected from the group of the n historical points of time and the target point of time, obtain the initial predicted position by using the position estimation model.

The control unit is configured to, after determining that the target object is located beyond the shooting blind spot at the n historical points of time and the target point of time, maintain or set the position estimation model at or to a non-operating state.

In some embodiments, performing at least two iterative stages according to the initial predicted position to obtain the position information of the target object at the target point of time includes: determining a relative position of the target object at the target point of time to a previous historical point of time, and using the relative position as the position information of the target object at the target point of time; or determining a relative position of the target object at the target point of time to a previous historical point of time, and determining the position information of the target object at the target point of time according to the relative position and historical position information of the target object at the previous historical point of time.

In some embodiments, the position estimation model is a dilated convolution neural network model, and a dilatation coefficient of the dilated convolution neural network model is not less than 2.

In some embodiments, the following operations are performed at convolutional layers of the position estimation model: performing preset processing on layer input data of a current convolutional layer twice to obtain layer output data, or performing preset processing on layer input data at least once and then combining the processed data with data from 1×1 convolution on the layer input data to obtain layer output data, wherein layer input data of a first layer of the position estimation model is the historical time queue and the posture change information, and the layer output data of the current convolutional layer is layer input data of next convolutional layer; and the preset processing includes: performing weight parameter normalized dilated convolution processing on the layer input data and then performing non-linear processing using an activation function, and performing processing by a discarding unit.

For the apparatus embodiment, since it substantially corresponds to the method embodiment, it is sufficient to refer to a part of the description of the method embodiment where relevant. The apparatus embodiments described above are merely exemplary, wherein the modules illustrated as separate modules may be or may not be separated. Some or all of the modules may be selected based on actual needs to achieve the objectives of the solutions of the embodiments. Those of ordinary skill in the art can understand and implement the present disclosure without creative effort.

The method and apparatus of the present disclosure has been described above based on embodiments and application examples. Moreover, the present disclosure further provides an electronic device and a computer-readable storage medium, which will be described below.

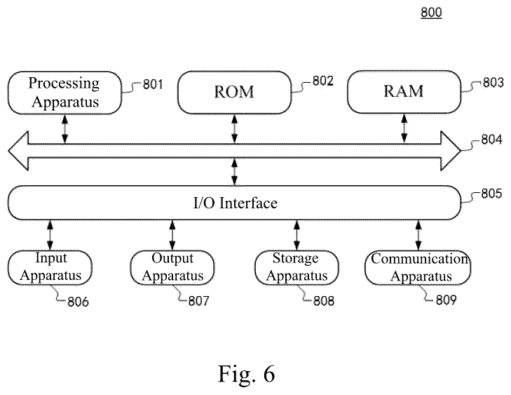

With reference to FIG. 6, there is shown a structural schematic diagram of an electronic device (e.g., a terminal device or a server) 800 adapted to implement the embodiments of the present disclosure. The terminal device in the embodiment of the present disclosure may include but not be limited to mobile terminals such as a mobile phone, a notebook computer, a digital broadcasting receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in the figure is merely an example, and should not pose any limitation to the functions and the range of use of the embodiments of the present disclosure.

The electronic device 800 may include a processing apparatus (e.g., a central processing unit, a graphics processing unit) 801, which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatuses may be connected to the I/O interface 805: an input apparatus 806 including, for example, a touch screen, a touch pad, a keyboard, a mouse, a camera, a microphone, an accelerometer, and a gyroscope; an output apparatus 807 including, for example, a liquid crystal display (LCD), a loudspeaker, and a vibrator; a storage apparatus 808 including, for example, a magnetic tape and a hard disk; and a communication apparatus 809. The communication apparatus 809 may allow the electronic device 800 to be in wireless or wired communication with other devices to exchange data. While the figure illustrates the electronic device 800 having various apparatuses, it is to be understood that all the illustrated apparatuses are not necessarily implemented or included. More or less apparatuses may be implemented or included alternatively.

Particularly, according to the embodiments of the present disclosure, the process described above with reference to the flowchart may be implemented as a computer software program. For example, an embodiment of the present disclosure includes a computer program product including a computer program carried on a computer-readable medium. The computer program includes a program code for executing the method shown in the flowchart. In such embodiments, the computer program may be downloaded online through the communication apparatus 809 and installed, or installed from the storage apparatus 808, or installed from the ROM 802. When the computer program is executed by the processing apparatus 801, the functions defined in the method of the embodiments of the present disclosure are executed.

It needs to be noted that the computer-readable medium described above in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination of them. More specific examples of the computer-readable storage medium may include, but be not limited to, an electrical connection with one or more wires, a portable computer disk, a hard disk, a random-access memory (RAM), a read-only memory (ROM), an erasable programmable read-only memory (EPROM or a flash memory), an optical fiber, a compact disk read-only memory (CD-ROM), an optical storage device, a magnetic storage device, or any appropriate combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal that propagates in a baseband or as a part of a carrier and carries thereon a computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable storage medium may send, propagate or transmit a program used by or in combination with an instruction execution system, apparatus or device. The program code included on the computer-readable medium may be transmitted by using any suitable medium, including but not limited to an electric wire, a fiber-optic cable, radio frequency (RF) and the like, or any appropriate combination thereof.

In some implementations, a client and a server may communicate by means of any network protocol currently known or to be developed in future such as HyperText Transfer Protocol (HTTP), and may achieve communication and interconnection with digital data (e.g., a communication network) in any form or of any medium. Examples of the communication network include a local area network (LAN), a wide area network (WAN), an Internet work (e.g., the Internet), a peer-to-peer network (e.g., ad hoc peer-to-peer network), and any network currently known or to be developed in future.

The above-mentioned computer-readable medium may be included in the electronic device described above, or may exist alone without being assembled with the electronic device.

The above-mentioned computer-readable medium carries one or more programs which, when executed by the electronic device, cause the electronic device to perform the method of the present disclosure described above.

Computer program code for performing the operations in the present disclosure may be written in one or more programming languages or a combination thereof. The programming languages include object-oriented programming languages, such as Java, Smalltalk, and C++, and conventional procedural programming languages, such as C or similar programming languages. The program code can be executed fully on a user's computer, executed partially on a user's computer, executed as an independent software package, executed partially on a user's computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider).

The flowcharts and block diagrams in the accompanying drawings illustrate system architectures, functions and operations that may be implemented by the system, method and computer program product according to the embodiments of the present disclosure. In this regard, each block in the flowcharts or block diagrams may represent a module, a program segment or a part of code, and the module, the program segment or the part of code includes one or more executable instructions for implementing specified logic functions. It should also be noted that in some alternative implementations, the functions marked in the blocks may alternatively occur in a different order from that marked in the drawings. For example, two successively shown blocks actually may be executed in parallel substantially, or may be executed in reverse order sometimes, depending on the functions involved. It should also be noted that each block in the flowcharts and/or block diagrams and combinations of the blocks in the flowcharts and/or block diagrams may be implemented by a dedicated hardware-based system for executing specified functions or operations, or may be implemented by a combination of dedicated hardware and computer instructions.

The units described in the embodiments of the present disclosure may be implemented by software, or may be implemented by hardware. The name of a unit does not constitute a limitation on the unit itself.

The functions described above herein may be performed at least in part by one or more hardware logic components. For example, exemplary types of hardware logic components that can be used without limitations include a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include but be not limited to an electronic, magnetic, optical, electromagnetic, infrared, or semiconductor system, apparatus or device, or any appropriate combination thereof. More specific examples of the machine-readable storage medium include: an electrical connection with one or more wires, a portable computer disk, a hard disk, a random-access memory (RAM), a read-only memory (ROM), an erasable programmable ROM (an EPROM or a flash memory), an optical fiber, a portable compact disc read-only memory (CD-ROM), an optical storage device, a magnetic storage device, or any suitable combination thereof.

According to one or more embodiments of the present disclosure, there is provided a method for determining a position, including: inputting a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and performing at least two iterative stages on the initial predicted position to obtain position information of the target object at the target point of time, wherein a positioning accuracy of any iterative stage is higher than a positioning accuracy of a previous iterative stage.

According to one or more embodiments of the present disclosure, there is provided a method for determining a position, wherein the following operations are performed at each iterative stage: determining error planes corresponding to a current iterative stage, wherein the error planes have respective error expectations; and a higher positioning accuracy of the current iterative stage indicates a smaller interval between the error expectations of the error planes corresponding to the current iterative stage; determining a probability that an input position falls within each of the error planes corresponding to the current iterative stage, wherein an input position of a first iteration is the initial predicted position, and input positions of other iterative stages are stage positions output from previous iterative stages; correcting the input position according to the probability that the input position falls within each of the error planes and the error expectation corresponding to the error plane to obtain a corrected position; and inputting the corrected position to the position estimation model to obtain a stage position of the current iterative stage.

According to one or more embodiments of the present disclosure, there is provided a method for determining a position, wherein the error planes are divided into different error levels; the error expectations of the error planes of one error level are arranged at an equal interval; intervals of the error expectations of the error planes of different error levels are different; one iterative stage corresponds to the error planes of one error level; and/or different iterative stages are used to determine different bits in a value of the position information of the target object at the target point of time.

According to one or more embodiments of the present disclosure, there is provided a method for determining a position, before the inputting a historical time queue and posture change information of a target object at a target point of time to a position estimation model to obtain an initial predicted position, further including: determining whether the target object is located in a shooting blind spot of a camera at n historical points of time in the historical time queue and the target point of time; in response to the target object being located beyond the shooting blind spot at the n historical points of time and the target point of time, using position information of the target object at the target point of time acquired by the camera as the position information of the target object at the target point of time; and in response to the target object being located in the shooting blind spot at at least one selected from the group of the n historical points of time and the target point of time, inputting the historical time queue and the posture change information to the position estimation model to obtain the initial predicted position.

According to one or more embodiments of the present disclosure, there is provided a method for determining a position, wherein after determining that the target object is located in the shooting blind spot at at least one selected from the group of the n historical points of time and the target point of time, the initial predicted position is obtained by using the position estimation model; and after determining that the target object is located beyond the shooting blind spot at the n historical points of time and the target point of time, the position estimation model is maintained at or set to a non-operating state.

According to one or more embodiments of the present disclosure, there is provided a method for determining a position, performing at least two iterative stages according to the initial predicted position to obtain the position information of the target object at the target point of time includes: determining a relative position of the target object at the target point of time to a previous historical point of time, and using the relative position as the position information of the target object at the target point of time; or determining a relative position of the target object at the target point of time to a previous historical point of time, and determining the position information of the target object at the target point of time according to the relative position and historical position information of the target object at the previous historical point of time.

According to one or more embodiments of the present disclosure, there is provided a method for determining a position, the position estimation model is a dilated convolution neural network model, and a dilatation coefficient of the dilated convolution neural network model is not less than 2.

According to one or more embodiments of the present disclosure, there is provided a method for determining a position, the following operations are performed at convolutional layers of the position estimation model: performing preset processing on layer input data of a current convolutional layer twice to obtain layer output data, or performing preset processing on layer input data at least once and then combining the processed data with data from 1×1 convolution on the layer input data to obtain layer output data; wherein layer input data of a first layer of the position estimation model is the historical time queue and the posture change information, and the layer output data of the current convolutional layer is layer input data of next convolutional layer; and the preset processing includes: performing weight parameter normalized dilated convolution processing on the layer input data and then performing non-linear processing using an activation function, and performing processing by a discarding unit.

According to one or more embodiments of the present disclosure, there is provided an apparatus for determining a position, including: a control unit configured to input a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2, wherein the control unit is further configured to perform at least two iterative stages according to the initial predicted position to obtain position information of the target object at the target point of time; and wherein a positioning accuracy of any iterative stage is higher than a positioning accuracy of a previous iterative stage.

According to one or more embodiments of the present disclosure, there is provided an electronic device, including at least one memory and at least one processor, wherein the at least one memory is configured to store a program code, and the at least one processor is configured to call the program code stored on the at least one memory to perform any method described above.

According to one or more embodiments of the present disclosure, there is provided a computer-readable storage medium, configured to store a program code which, when run by a processor, causes the processor to perform the method described above.

The above description merely provides exemplary embodiments and explanations of the technical principles employed. Those skilled in the art should understand that the scope of the disclosure herein is not limited to the specific combinations of technical features described above but should also cover other technical solutions formed by any combination of the aforementioned technical features or their equivalents without departing from the concept disclosed herein. For example, technical solutions formed by substituting the aforementioned features with other technical features disclosed in this disclosure (but not limited to) that have similar functions.

Furthermore, although the operations are depicted in a specific order, this should not be understood as requiring these operations to be performed in the illustrated specific order or sequential order. In certain environments, multitasking and parallel processing may be advantageous. Similarly, although several specific implementation details are included in the above discussion, these should not be interpreted as limiting the scope of the disclosure. Certain features described in the context of separate embodiments can also be implemented in combination in a single embodiment. Conversely, various features described in the context of a single embodiment can also be implemented separately or in any suitable sub-combination across multiple embodiments.

Although the subject matter has been described with specificity regarding structural features and/or methodological actions, it should be understood that the subject matter defined in the appended claims is not necessarily limited to the specific features or actions described above. Rather, the specific features and acts described above are merely exemplary forms of implementing the claims.

1. A method for determining a position, comprising:
inputting a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and
performing at least two iterative stages on the initial predicted position to obtain position information of the target object at the target point of time,
wherein a positioning accuracy of any iterative stage is higher than a positioning accuracy of a previous iterative stage.

2. The method according to claim 1, wherein the following operations are performed at each of the iterative stages:
determining error planes corresponding to a current iterative stage, wherein the error planes have respective error expectations; and a higher positioning accuracy of the current iterative stage indicates a smaller interval between the error expectations of the error planes corresponding to the current iterative stage;
determining a probability that an input position falls within each of the error planes corresponding to the current iterative stage, wherein an input position of a first iteration is the initial predicted position, and input positions of subsequent iterative stages are stage positions output from previous iterative stages;
correcting the input position according to the probability that the input position falls within each of the error planes and the error expectation corresponding to the error plane to obtain a corrected position; and
inputting the corrected position to the position estimation model to obtain a stage position of the current iterative stage.

3. The method according to claim 1, wherein the error planes are divided into different error levels; the error expectations of the error planes of one error level are arranged at an equal interval; intervals of the error expectations of the error planes of different error levels are different; one iterative stage corresponds to the error planes of one error level; or
wherein different iterative stages are used to determine different bits in a value of the position information of the target object at the target point of time.

4. The method according to claim 1, before the inputting a historical time queue and posture change information of a target object at a target point of time to a position estimation model to obtain an initial predicted position, further comprising:
determining whether the target object is located in a shooting blind spot of a camera at n historical points of time in the historical time queue and the target point of time;
in response to the target object being located beyond the shooting blind spot at the n historical points of time and the target point of time, using position information of the target object at the target point of time acquired by the camera as the position information of the target object at the target point of time; and
in response to the target object being located in the shooting blind spot at at least one point of time selected from the group of the n historical points of time and the target point of time, inputting the historical time queue and the posture change information to the position estimation model to obtain the initial predicted position.

5. The method according to claim 4, wherein:
after determining that the target object is located in the shooting blind spot at at least one point of time selected from the group of the n historical points of time and the target point of time, the initial predicted position is obtained by using the position estimation model; and
after determining that the target object is located beyond the shooting blind spot at the n historical points of time and the target point of time, the position estimation model is maintained at or set to a non-operating state.

6. The method according to claim 1, wherein the performing at least two iterative stages according to the initial predicted position to obtain position information of the target object at the target point of time comprises:
determining a relative position of the target object at the target point of time to a previous historical point of time, and using the relative position as the position information of the target object at the target point of time; or
determining a relative position of the target object at the target point of time to a previous historical point of time, and determining the position information of the target object at the target point of time according to the relative position and historical position information of the target object at the previous historical point of time.

7. The method according to claim 1, wherein:
the position estimation model is a dilated convolution neural network model, and a dilatation coefficient of the dilated convolution neural network model is not less than 2.

8. The method according to claim 7, wherein the following operations are performed at each convolutional layer of the position estimation model:
performing preset processing on layer input data of a current convolutional layer twice to obtain layer output data, or performing preset processing on layer input data at least once and then combining the processed data with data from 1×1 convolution on the layer input data to obtain layer output data,
wherein layer input data of a first layer of the position estimation model is the historical time queue and the posture change information, and the layer output data of the current convolutional layer is layer input data of next convolutional layer; and
wherein the preset processing comprises: performing weight parameter normalized dilated convolution processing on the layer input data and then performing non-linear processing using an activation function, and performing processing by a discarding unit.

9. An electronic device, comprising:
at least one memory and at least one processor;
wherein the at least one memory is configured to store a program code, and the at least one processor is configured to execute the program code stored on the at least one memory and cause the electronic device to:
input a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and
perform at least two iterative stages on the initial predicted position to obtain position information of the target object at the target point of time,
wherein a positioning accuracy of any iterative stage is higher than a positioning accuracy of a previous iterative stage.

10. The electronic device according to claim 9, wherein at each of the iterative stages, the electronic device is caused to:
determine error planes corresponding to a current iterative stage, wherein the error planes have respective error expectations; and a higher positioning accuracy of the current iterative stage indicates a smaller interval between the error expectations of the error planes corresponding to the current iterative stage;
determine a probability that an input position falls within each of the error planes corresponding to the current iterative stage, wherein an input position of a first iteration is the initial predicted position, and input positions of subsequent iterative stages are stage positions output from previous iterative stages;
correct the input position according to the probability that the input position falls within each of the error planes and the error expectation corresponding to the error plane to obtain a corrected position; and
input the corrected position to the position estimation model to obtain a stage position of the current iterative stage.

11. The electronic device according to claim 9, wherein the error planes are divided into different error levels; the error expectations of the error planes of one error level are arranged at an equal interval; intervals of the error expectations of the error planes of different error levels are different; one iterative stage corresponds to the error planes of one error level; or
wherein different iterative stages are used to determine different bits in a value of the position information of the target object at the target point of time.

12. The electronic device according to claim 9, before the inputting a historical time queue and posture change information of a target object at a target point of time to a position estimation model to obtain an initial predicted position, the electronic device is further caused to:
determine whether the target object is located in a shooting blind spot of a camera at n historical points of time in the historical time queue and the target point of time;
in response to the target object being located beyond the shooting blind spot at the n historical points of time and the target point of time, use position information of the target object at the target point of time acquired by the camera as the position information of the target object at the target point of time; and
in response to the target object being located in the shooting blind spot at at least one point of time selected from the group of the n historical points of time and the target point of time, input the historical time queue and the posture change information to the position estimation model to obtain the initial predicted position.

13. The electronic device according to claim 12, wherein:
after determining that the target object is located in the shooting blind spot at at least one point of time selected from the group of the n historical points of time and the target point of time, the initial predicted position is obtained by using the position estimation model; and
after determining that the target object is located beyond the shooting blind spot at the n historical points of time and the target point of time, the position estimation model is maintained at or set to a non-operating state.

14. The electronic device according to claim 9, wherein the electronic device is further caused to:
determine a relative position of the target object at the target point of time to a previous historical point of time, and using the relative position as the position information of the target object at the target point of time; or
determine a relative position of the target object at the target point of time to a previous historical point of time, and determining the position information of the target object at the target point of time according to the relative position and historical position information of the target object at the previous historical point of time.

15. The electronic device according to claim 9, wherein:
the position estimation model is a dilated convolution neural network model, and a dilatation coefficient of the dilated convolution neural network model is not less than 2.

16. The electronic device according to claim 15, wherein the electronic device is caused to perform the following operations are performed at each convolutional layer of the position estimation model:
performing preset processing on layer input data of a current convolutional layer twice to obtain layer output data, or performing preset processing on layer input data at least once and then combining the processed data with data from 1×1 convolution on the layer input data to obtain layer output data,
wherein layer input data of a first layer of the position estimation model is the historical time queue and the posture change information, and the layer output data of the current convolutional layer is layer input data of next convolutional layer; and
wherein the preset processing comprises: performing weight parameter normalized dilated convolution processing on the layer input data and then performing non-linear processing using an activation function, and performing processing by a discarding unit.

17. A computer-readable storage medium, configured to store a program code which, when executed by a processor, causes the processor to:
input a historical time queue and posture change information of a target object at a target point of time to a position estimation model to obtain an initial predicted position, wherein the historical time queue is used for storing historical position information of the target object at latest n historical points of time prior to the target point of time, and n is a preset positive integer not less than 2; and
perform at least two iterative stages on the initial predicted position to obtain position information of the target object at the target point of time,
wherein a positioning accuracy of any iterative stage is higher than a positioning accuracy of a previous iterative stage.

18. The medium according to claim 17, wherein at each of the iterative stages, the electronic device is caused to:
determine error planes corresponding to a current iterative stage, wherein the error planes have respective error expectations; and a higher positioning accuracy of the current iterative stage indicates a smaller interval between the error expectations of the error planes corresponding to the current iterative stage;
determine a probability that an input position falls within each of the error planes corresponding to the current iterative stage, wherein an input position of a first iteration is the initial predicted position, and input positions of subsequent iterative stages are stage positions output from previous iterative stages;
correct the input position according to the probability that the input position falls within each of the error planes and the error expectation corresponding to the error plane to obtain a corrected position; and
input the corrected position to the position estimation model to obtain a stage position of the current iterative stage.

19. The medium according to claim 17, wherein the error planes are divided into different error levels; the error expectations of the error planes of one error level are arranged at an equal interval; intervals of the error expectations of the error planes of different error levels are different; one iterative stage corresponds to the error planes of one error level; and
wherein different iterative stages are used to determine different bits in a value of the position information of the target object at the target point of time.

20. The medium according to claim 17, before the inputting a historical time queue and posture change information of a target object at a target point of time to a position estimation model to obtain an initial predicted position, the electronic device is further caused to:
determine whether the target object is located in a shooting blind spot of a camera at n historical points of time in the historical time queue and the target point of time;
in response to the target object being located beyond the shooting blind spot at the n historical points of time and the target point of time, use position information of the target object at the target point of time acquired by the camera as the position information of the target object at the target point of time; and
in response to the target object being located in the shooting blind spot at at least one point of time selected from the group of the n historical points of time and the target point of time, input the historical time queue and the posture change information to the position estimation model to obtain the initial predicted position.
